(19) United States
(12) Patent Application Publication
(10) Pub. No.: US 2003/0105931 A1
(43) Pub. Date: Jun. 5, 2003

(54) Architecture for transparent mirroring

(76) Inventors: Bret S. Weber, Wichita, KS (US); Russell J. Henry, Wichita, KS (US); Dennis E. Gates, Wichita, KS (US); Keith W. Holt, Wichita, KS (US); John V. Sherman, Derby, KS (US)

Correspondence Address: LSI LOGIC CORPORATION, 1621 BARBER LANE, MS D-106, LEGAL DEPARTMENT, MILPITAS, CA, 95035, US

(21) Appl. No.: 09/997,756

(22) Filed: Nov. 30, 2001

(51) Int. Cl. G06F 13/00

(52) U.S. Cl. 711/162

(57) ABSTRACT

The present invention is directed to an architecture for transparent mirroring. A method of providing data redundancy in a data storage system may include receiving a request by a first data storage device controller for data access operation. Data is written to a local storage device and a data access operation performed by a second data storage device controller communicatively coupled to the first data storage device controller over an interconnect fabric simultaneously. The second data storage device controller communicatively coupled to a second data storage device.

### FIELD OF THE INVENTION

The present invention generally relates to the field of data storage, and particularly to an architecture for transparent data storage mirroring.

### BACKGROUND OF THE INVENTION

Electronic data storage is one of the most important aspects of the modern life. From bank account information and e-commerce to research and business data, most every aspect of modern life has some element that requires the storage of electronic data. Because of the importance of this data, it is desirable to provide persistent access to uncorrupted data.

Additionally, because of the great advances have been made in the components utilized in information handling systems, such as desktop computers, servers, information appliances, convergence devices, and the like, it is desirable to provide an electronic data storage architecture that will take advantage of the increased functionality. For example, faster processors, network connection devices, memories, and the like are constantly available which enable components and the host system itself to provide desired functions in an efficient manner.

However, previous data storage architectures hindered the use of these systems by serving as a bottleneck in the manipulation of data, such as through inefficient access and storage of electronic data. Thus, it would be desirable to provide an architecture that would enable persistent uncorrupted data access without hindering these improved systems.

Therefore, it would be desirable to provide an architecture for transparent mirroring.

### SUMMARY OF THE INVENTION

Accordingly, the present invention is directed to an architecture for transparent mirroring. In a first aspect of the present invention, a method of providing data redundancy in a data storage system includes receiving a request by a first data storage device controller for remote data memory access (RDMA) operation. Data is written to a local storage device and a remote data memory access operation performed by a second data storage device controller communicatively coupled to the first data storage device controller over an interconnect fabric simultaneously. The second data storage device controller communicatively coupled to a second data storage device.

In a second aspect of the present invention, a data storage system suitable for providing data mirroring includes a first data storage apparatus including a first controller suitable for performing data storage operations, a buffer communicatively coupled to the first controller, the buffer suitable for storing data and a first data storage device communicatively coupled to the first controller, the first data storage device suitable for storing electronic data. A second data storage apparatus is communicatively coupled to the first data storage apparatus, the second data storage apparatus including a second controller suitable for performing data storage operations and a second data storage device communicatively coupled to the second controller, the second data storage device suitable for storing electronic data. When a request is received by the first controller to perform a memory access operation, the first controller writes data to the first data storage device and requests a remote data memory access by the second controller.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an illustration of an embodiment of the present invention wherein an architecture including redundant controllers is provided for transparent data mirroring in a data storage system;

FIG. 2 is a block diagram illustrating an embodiment of the present invention wherein a data storage device architecture utilizes an interconnect fabric to provide connectivity;

FIG. 3 is a flow chart depicting an exemplary method of the present invention wherein data is transparently mirrored without a performance penalty;

FIG. 4 is a flow chart of an exemplary method of the present invention wherein a remote data memory access operation is received and processed by redundant memory controllers to provide transparent data mirroring; and

FIG. 5 is an illustration of an exemplary embodiment of the present invention wherein memory controllers provide mirrored access between multiple data storage devices.

### DETAILED DESCRIPTION OF THE INVENTION

Reference will now be made in detail to the presently preferred embodiments of the invention, examples of which are illustrated in the accompanying drawings.

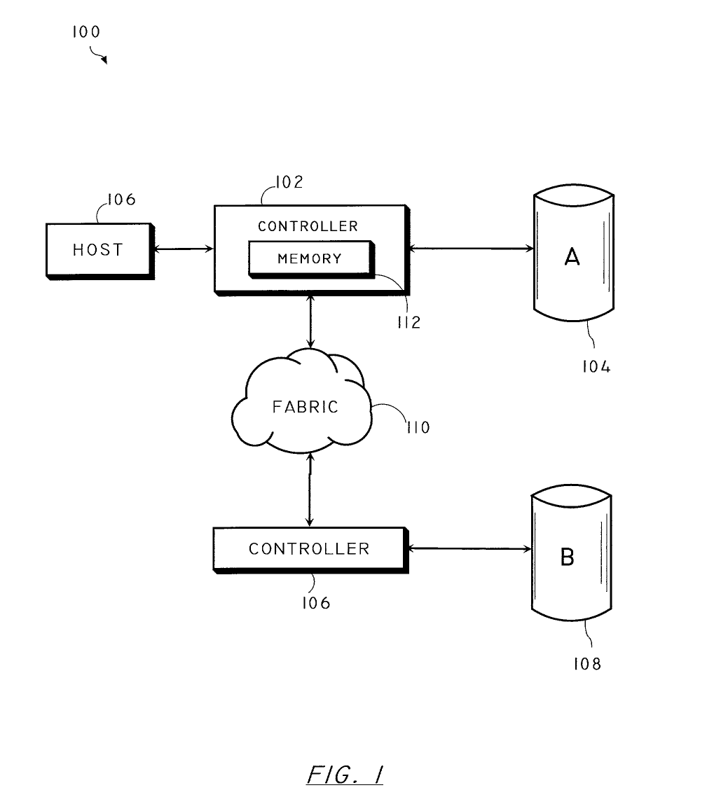

Referring generally now to FIGS. 1 through 5, exemplary embodiments of the present invention are shown. Because of the importance of electronic data storage, it is desirable to provide persistent access to uncorrupted data. Methods utilized to provide this access to uncorrupted data may include the use of data backup, such as RAID arrays and the like. However, previous solutions used separate scheduled operations through a bus interface, which caused long latencies and consumed a high degree of bandwidth, such as two times the bandwidth and more, than was required to provide a non-backed-up version. Therefore, users desiring to avail themselves of the data integrity and accessibility of these systems had to deal with performance penalties, which may affect not only the data storage system, but also the overall system. The present invention provides an architecture for transparent mirroring that does not suffer from such performance penalties, thereby giving a user persistent access to data, the data existing in an uncorrupted state.

Referring now to FIG. 1, an embodiment 100 of the present invention is shown wherein an architecture including redundant controllers is provided for transparent data mirroring in a data storage system. A first controller 102 is provided to control data storage and access operations of a data storage device 104, such as for a RAID array, single electronic data storage device, and the like. For instance, the controller 102 may receive a request to store data from a host 106 on a data storage device 104, and may utilize the controller 102 to store the data on space available on the data storage device 104. To provide data redundancy, a second controller 104 is provided 106 to mirror data on a second data storage device 108. Thus, should the first data storage device 104 become unavailable, the second data storage device 108 may provide access to data. A memory 112 is provided to store data received from the host 106 to be written to both the first data storage device 104 and the second data storage device 108.

Previous data mirroring system used separate scheduled operations through bus interfaces, which caused long latencies and were resource intensive. The architecture of the present invention provides a fabric 110 between the first controller 102 and the second controller 106 to enable efficient data transmission with no additional memory bandwidth consumption.

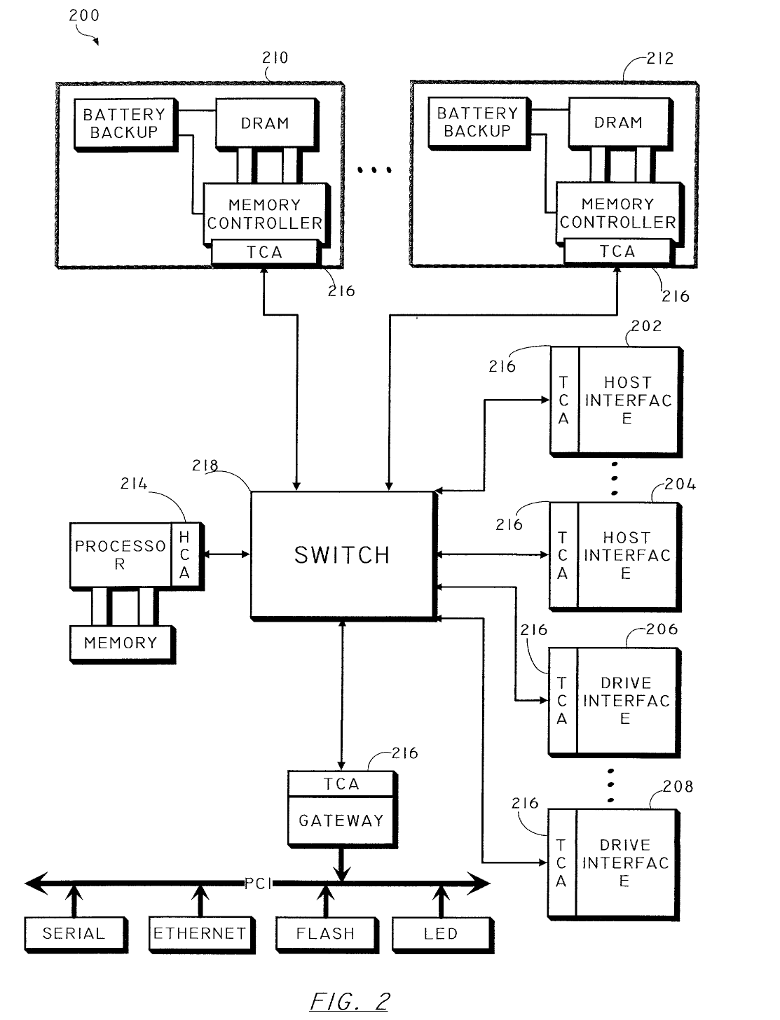

For example, referring now to FIG. 2, an embodiment of the present invention is shown wherein a data storage device architecture utilizes an interconnect fabric to provide connectivity. An electronic data storage device architecture 100 may include a plurality of electronic storage devices to provide data redundancy, such as a disk array arranged in a RAID array, and the like. To provide connectivity between components, the present invention may utilize a fabric interconnect.

A fabric interconnect of the present invention provides scalability by not limiting the number of host interfaces 202 & 204 and drive interfaces 206 & 208. Additionally, the number of modules in a controller 210 & 212 is not limited by the fabric like the physical limits PCI has on the number of connections to the bus.

To provide this increased functionality, the fabric interconnect may utilize messages, which in this instance is defined as a logical unit of work, to execute transactions. For example, message semantics may support memory operations such as remote direct memory access (RDMA) reads, writes, and channel operations such as send, receive, and the like.

Messages may be further segmented into packets. Data packets are an end-to-end fabric unit of transfer, e.g. packets are the routable unit of transfer. Hardware of the present invention may provide automatic message segmentation and re-assembly via packets. Packets include headers to identify the packet destination and the desired data. For example, packets may include a local route header (LRH), global route header (GRH), base transport header (BTH), extended transport header (ExTH), intermediate data, a message payload, an invariant CRC, a variant CRC, and the like.

A host channel adapter (HCA) 214 is generally a host concept configured for computing platforms. For example, a HCA may be configured for high end devices, such as nodes, memory array controllers, and the like. Functions of a HCA may include implementation of a link protocol in hardware, implement software verbs, as a RDMA engine, work queue engine, memory registration and protection, and the like as contemplated by a person of ordinary skill in the art. Thus, the HCA 214 may act to implement high-end devices in the architecture of the present invention. However, there may be implementations where the full level of functionality of an HCA is not desired, such as specialized subsystems.

Target channel adapters (TCA) 216 may be configured for specialized subsystems. TCA may be configured as simpler than HCA so that it implements what is required to minimally support fabric architecture and device-specific functionality. For example, a TCA may be configured as a work queue engine, a link protocol engine, implement transport, and the like without departing from the spirit and scope of the present invention.

To ensure packet delivery within a fabric interconnect, a switch 218 may be provided. For instance, the switch may operate as a packet-switching element within a fabric subnet. Packets may be switched, for example, based on a local identifier (LID) within the local route header (LRH) as described previously. A router, which may be though of as a superset of a switch, may also be provided to enable packet routing between systems.

Thus, by providing a fabric interconnect, a high bandwidth electronic data storage device controller architecture may be provided to enable data mirroring to be performed in a transparent and efficient matter through utilization of the present invention. A further discussion of use of an interconnect may be found in U.S. patent application Ser. No. 09/880,668, titled “High Bandwidth Storage Device Architecture”, filed Jun. 13, 2001, Attorney Docket Number LSI 01-195, pending, which is herein incorporated by reference in its entirety.

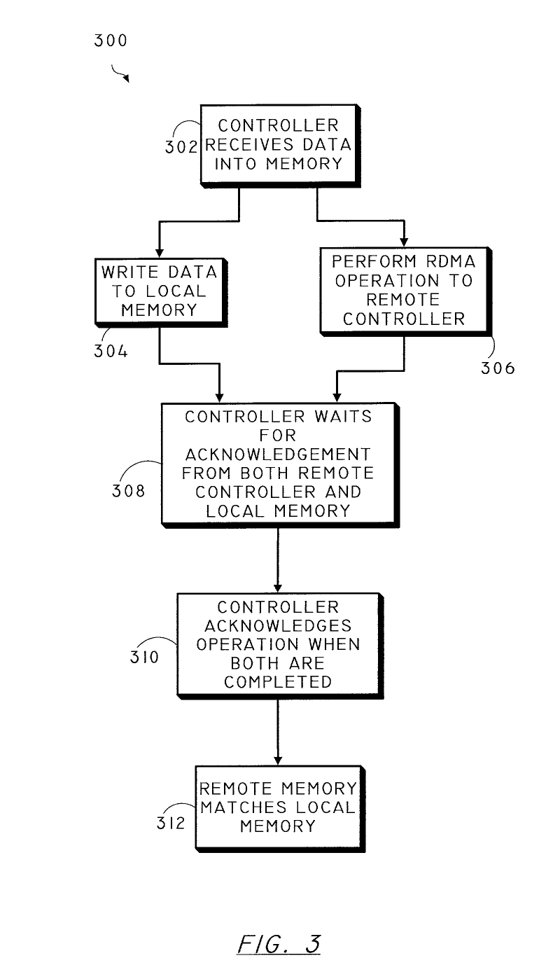

Referring now to FIG. 3, an exemplary method 300 of the present invention is shown wherein data is transparently mirrored without a performance penalty. A controller receives data 302 into memory, such as a holding FIFO, from a host to write to a local storage device and a remote storage device. The controller writes data to a local memory 304, such as the first storage device shown in FIG. 1, and performs a remote data memory access operation to a remote controller 306, such as the second controller 106 shown in FIG. 1. The controller writes data to the local memory and performs the remote data memory access operation simultaneously. Thus, by providing a fabric connection, such as an InfiniBand connection and the like, the controller may mirror over a private InfiniBand channel transparently without software interaction, and without a memory bandwidth or input/output channel penalty.

The controller then waits from acknowledgement from both the remote controller and the local memory of completion of the respective operations 308, and upon receiving acknowledgments, returns completion of the operation 310 to the host. Thus, the local memory is mirrored by the remote memory 312 so that the data may continue to be provided even in the instance of device failure. In this way, the present invention provides higher performance without additional memory bandwidth consumption, which may be utilized to free up additional memory bandwidth for RAID operations, interface bandwidth, and the like.

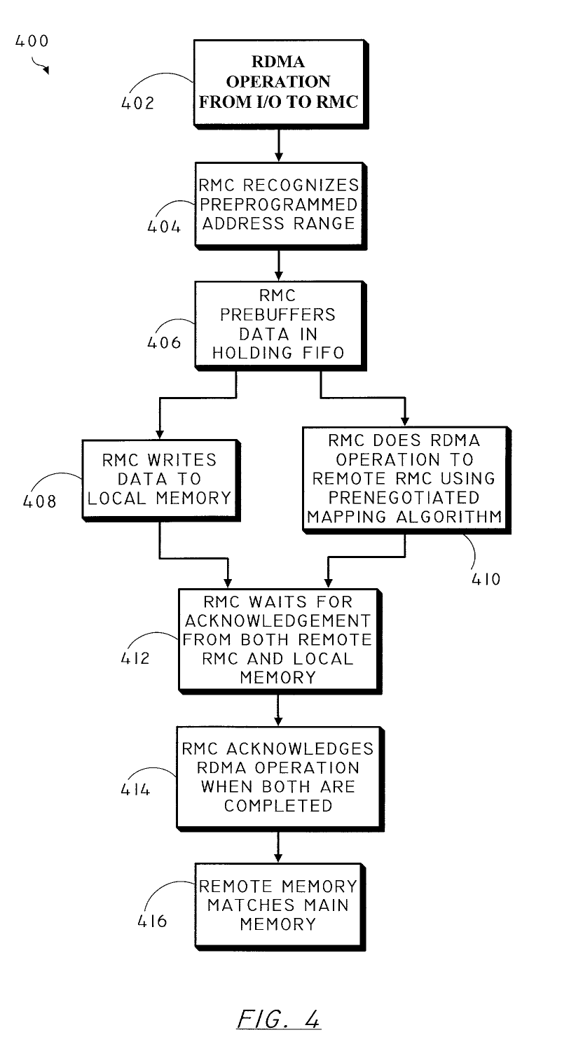

Referring now to FIG. 4, an exemplary method 400 of the present invention is shown wherein a remote data memory access operation is received and processed by redundant memory controllers to provide transparent data mirroring. A remote data memory access operation is sent from an input/output interface to a redundant memory controller 402. The RMC recognizes a preprogrammed address range 404 as a range specified for data mirroring. The RMC pre-buffers the data into a holding FIFO memory 406.

The RMC then simultaneously writes data to local memory 408 and does a RDMA operation to a remote redundant memory controller using a pre-negotiated mapping algorithm 410. The redundant memory controller waits for acknowledgement from both the remote redundant memory controller and local memory 412. Once acknowledgement is received of both operations, the RMC returns an indication of completion of the operation 414 to the input/output interface. Thus, the remote memory now matches the main memory 416, so that if unavailability of a device is encountered, the data may still be accessed.

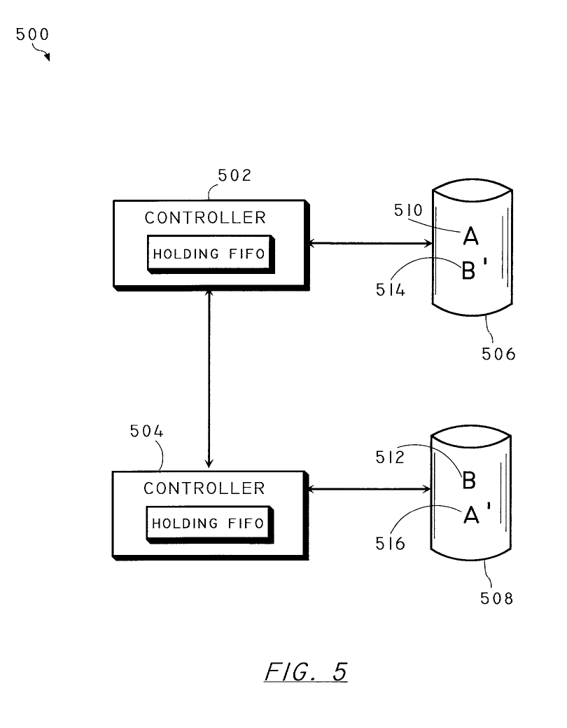

Referring now to FIG. 5, an embodiment 500 illustrating an architecture of the present invention is shown wherein memory controllers provide mirrored access between multiple data storage devices. A first controller 502 and a second controller 504 may provide data mirroring utilizing respective locally connected data storage devices. For example, the first controller 502 may be connected locally to a first data storage device 506 to provide data storage and retrieval. Likewise, the second controller 504 is connected locally to a second data storage device 508.

Each data storage device 506 & 508 may be utilized to store electronic data 510 & 512 directed to that particular device. Additionally, through use of the present invention, the data storage devices 506 & 508 may provide data mirrored from the other device 514 & 516. For example, the first controller 502 may receive a RDMA operation to be performed, and write data 510 to the first data storage device 506 and perform a RDMA operation to the second controller 504 to store mirrored data 516, thereby providing a redundant copy of the data should the first data storage device 506 become unavailable. Additionally, the second controller 504 may receive a RDMA operation and write data 512 to the second data storage device 508 as well as perform a RDMA operation to the first controller 502 to provide a back-up copy of the data 514 on the first data storage device 506.

Thus, each data storage device provides primary data for which the devices is responsible for, as well as a transparent back-up copy should the other device become unavailable. Although two data storage devices and controllers are discussed, it should be apparent that a person of ordinary skill in the art may use a variety of data storage devices and controllers without departing from the spirit and scope of the present invention.

It is believed that the architecture for transparent mirroring of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A method of providing data redundancy in a data storage system, comprising:
receiving a request by a first data storage device controller for a data access operation; and
writing data to a local storage device and performing a data access operation to a second data storage device controller communicatively coupled to the first data storage device controller over an interconnect fabric simultaneously, the second data storage device controller communicatively coupled to a second data storage device.

2. The method as described in claim 1, wherein the first data storage device controller recognizes a preprogrammed address range of the request, the preprogrammed range indicating a desire for data mirroring.

3. The method as described in claim 1, wherein the first data storage device buffers data included in the request.

4. The method as described in claim 3, wherein the data is buffered in a FIFO buffer.

5. The method as described in claim 1, further comprising indicating completion of the data access operation including a RDMA operation to a requester upon receipt by the first data storage device controller of completion of both the data write to the local storage device and the data access operation by the second data storage device controller.

6. The method as described in claim 1, wherein the first data storage device controller is communicatively coupled to the second data storage device controller by utilizing an interconnect fabric including InfiniBand.

7. The method as described in claim 1, further comprising receiving a request by the second data storage device controller for a data access operation and writing data to a second storage device and requesting a data access operation by the first data storage device controller simultaneously, the second data storage device controller communicatively coupled to a second data storage device

8. A data storage system suitable for providing data mirroring, comprising a first data storage apparatus including;
a first controller suitable for performing data storage operations;
a buffer communicatively coupled to the first controller, the buffer suitable for storing data; and
a first data storage device communicatively coupled to the first controller, the first data storage device suitable for storing electronic data; and
a second data storage apparatus communicatively coupled to the first data storage apparatus, the second data storage apparatus including;
a second controller suitable for performing data storage operations; and
a second data storage device communicatively coupled to the second controller, the second data storage device suitable for storing electronic data;
wherein a request is received by the first controller to perform a remote data memory access (RDMA) operation, the first controller writes data to the first data storage device and requests a remote data memory access by the second controller.

9. The data storage system as described in claim 8, wherein the first controller recognizes a preprogrammed address range of the request, the preprogrammed range indicating a desire for data mirroring.

10. The data storage system as described in claim 8, wherein the first data storage device buffers data included in the request in the buffer.

11. The data storage system as described in claim 10, wherein the buffer is a FIFO buffer.

12. The data storage system as described in claim 8, further comprising indicating completion of the RDMA operation to a RDMA requestor upon receipt by the first controller of completion of both the data write to the first storage device and the remote data memory access operation by the second controller.

13. The data storage system as described in claim 8, wherein the first controller is communicatively coupled to the second controller utilizing an interconnect fabric including InfiniBand.

14. The data storage system as described in claim 8, wherein a request is received by the second controller to perform a remote data memory access (RDMA) operation, the second controller writes data to the second data storage device and requests a remote data memory access by the first controller.

15. The data storage system as described in claim 14, wherein the first data storage device includes data sent to be written to the first data storage device and data mirrored from the second data storage device and wherein the second data storage device includes data sent to be written to the second data storage device and data mirrored from the first data storage device.

16. The data storage system as described in claim 8, wherein the first controller writes data to the first data storage device and requests a remote data memory access by the second controller simultaneously.

17. A system of providing data redundancy in a data storage system, comprising:
means for receiving a request, by a first means for controlling a means for storing electronic data, for remote data memory access (RDMA) operation; and
means for writing data to a local first means for storing electronic data and performing a remote data memory access operation to a second means for controlling a means for storing electronic data communicatively coupled to the first controller means over an interconnect fabric simultaneously, the second controller means communicatively coupled to a second data storage means.

18. The data storage system as described in claim 17, wherein a request is received by the second controller means to perform a remote data memory access (RDMA) operation, the second controller means writes data to the second data storage means and requests a remote data memory access by the first controller means.

19. The data storage system as described in claim 18, wherein the first data storage means includes data sent to be written to the first data storage means and data mirrored from the second data storage means and wherein the second data storage means includes data sent to be written to the second data storage means and data mirrored from the first data storage means.

20. The data storage system as described in claim 17, wherein the first data storage means includes a means for buffering electronic data.
